(19) United States
(12) Patent Application Publication
(10) Pub. No.: US 2026/0109050 A1
(43) Pub. Date: Apr. 23, 2026

(54) OPEN CONTAINER GRIPPING APPARATUSES AND METHODS FOR HANDLING OPEN CONTAINERS

(71) Applicant: Toyota Research Institute, Inc., Los Altos, CA (US)

(72) Inventor: Lukas Sebastian Kaul, Mountain View, CA (US)

(73) Assignees: Toyota Research Institute, Inc., Los Altos, CA (US); Toyota Jidosha Kabushiki Kaisha, Aichi-ken (JP)

(21) Appl. No.: 18/918,403

(22) Filed: Oct. 17, 2024

(51) Int. Cl. B25J 15/00; B25J 15/02

(52) U.S. Cl. CPC B25J 15/0047; B25J 15/0014; B25J 15/0206

(57) ABSTRACT

Methods and apparatus for handling open containers using a gripper assembly are disclosed. A container gripper assembly includes a gripper. The gripper includes a base comprising a front end and a back end, a fixed part comprising a top end and a bottom end, the base and the fixed part joined at the back end of the base and the top end of the fixed part to form a substantially right angle, and a moving part comprising a pivot end and a contact end, the pivot end mechanically coupled to the base and configured to move the moving part along a longitudinal direction of the base such that the contact end is configured to engage a sidewall of the open container against a contact surface of the fixed part at an inner side of the right angle.

### TECHNICAL FIELD

The present disclosure relates to automated object handling technology, and more particularly, to open-container gripping devices and methods for handling open containers.

### BACKGROUND

Open boxes such as totes and other open containers are extensively employed for transporting various types of objects. These boxes are tightly packed and stacked in the back of trucks or box holders. Unloading such stacked boxes is a labor-intensive process that is common in many supply chains. This involves workers climbing into the trucks or the box holders in a warehouse and manually picking up each box and placing them on a conveyance mechanism. Therefore, there is a need for an open-container gripper assembly that can rapidly, accurately, and efficiently unload high-stacking boxes.

### SUMMARY

In accordance with one embodiment of the present disclosure, a container gripper assembly for handling an open container, the container gripper assembly includes a gripper. The gripper includes a base, a fixed part, and a moving part. The base includes a front end and a back end. The fixed part includes a top end and a bottom end. The base and the fixed part joined at the back end of the base and the top end of the fixed part to form a substantially right angle. The moving part includes a pivot end and a contact end. The pivot end is mechanically coupled to the base and configured to move the moving part along a longitudinal direction of the base such that the contact end is configured to engage a sidewall of the open container against a contact surface of the fixed part at an inner side of the right angle.

In accordance with another embodiment of the present disclosure, a method for handling an open container using a container gripper assembly including a gripper, the method includes lowering the gripper to contact a moving part of the gripper with a top edge of a sidewall of the open container, moving the moving part toward a front end of a base of the gripper, moving the gripper to engage a contact surface of a fixed part of the gripper at an inner side of a right angle against an outer surface of the sidewall, moving the moving part toward a back end of the base until a contact end of the moving part engages an inner surface of the sidewall, and lifting or titling the open container. The gripper includes the base, the fixed part, and the moving part. The base includes the front end and the back end. The fixed part includes a top end and a bottom end. The base and the fixed part joined at the back end of the base and the top end of the fixed part to form the substantially right angle. The moving part includes a pivot end and the contact end, the pivot end mechanically coupled to the base and configured to move the moving part along a longitudinal direction of the base.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts an example open-container gripper assembly of the present disclosure, according to one or more embodiments described and illustrated herein;

FIG. 2A schematically depicts a top view of an example open-container gripper of the present disclosure, according to one or more embodiments described and illustrated herein;

FIG. 2B schematically depicts a side view of an example open-container gripper as depicted in FIG. 2A of the present disclosure, according to one or more embodiments described and illustrated herein;

FIG. 3A schematically depicts an example open-container gripper approaching an open container in the process of lifting or tilting the open container, according to one or more embodiments described and illustrated herein;

FIG. 3B schematically depicts an example open-container gripper engaging the open container from the top in the process of handling the open container, according to one or more embodiments described and illustrated herein;

FIG. 3C schematically depicts an example open-container gripper engaging the open container from right in the process of handling the open container, according to one or more embodiments described and illustrated herein;

FIG. 3D schematically depicts an example open-container gripper engaging the open container from inside of the open container in the process of handling the open container, according to one or more embodiments described and illustrated herein;

FIG. 3E schematically depicts an example open-container gripper lifting or tilting the open container in the process of handling the open container, according to one or more embodiments described and illustrated herein;

FIG. 4A schematically depicts an example open-container gripper assembly sliding a support underneath the tilted or lifted open container in the process of handling the open container, according to one or more embodiments described and illustrated herein;

FIG. 4B schematically depicts an example open-container gripper assembly releasing the open container on the support in the process of handling the open container, according to one or more embodiments described and illustrated herein; and

FIG. 5 illustrates a flow diagram of an illustrative method of handling the open container using the open-container gripper assembly, according to one or more embodiments described and illustrated herein.

### DETAILED DESCRIPTION

The disclosed embodiments present apparatuses and methods for handling open containers using a container gripper assembly. An open-container gripper assembly is a tool designed for manipulating open containers or other objects by tilting, lifting, arranging, moving, or the like. In warehouse environments or other applications, such as on trucks, containers like open containers are often tightly packed, which creates challenges such as limited accessibility, restricted movement space, time inefficiency, and difficulties in securely grasping a wide variety of containers. Automating the process of picking, transporting, and placing open containers like totes remains a complex task due to the diversity of container designs, sizes, shapes, materials, and load types. Additional factors like cramped spaces between containers, the need for precise gripping, and the risk of spillage during movement further complicate automation. To overcome these challenges, robots must utilize advanced grippers like vacuum suction cups, soft grippers, or clamping systems capable of adapting to various container types and weights. Existing robotic approaches fail here due to the lack of standardization and mechanical features of the open containers. Current humanoid robots with strong hands or dedicated grippers can handle open containers only when sufficient space exists between the open containers to accommodate the robot's grippers, limiting their use in tightly packed environments. Further, current robot grippers manipulate the open containers by gripping the front top edge of the open containers, posing difficulties in managing the container's weight, preventing tipping or spillage, and avoiding damage from excessive bending.

The embodiments described herein address the challenges provided above by using a container gripper assembly including a gripper and a support. The container gripper assembly can lift or tilt the open containers using the gripper, and slide the support underneath to support the open container for further handling. The open-container gripper assembly described herein uses a relatively small area above the top of the open container and does not require a vacuum pump. Further, the open-container gripper assembly is compatible with different systems and may be mounted to a robot arm as a mechanical end-effector, a human-operated push-cart, a forklift, or a palletizer.

Throughout the disclosure, an open container refers to a container, for which a top surface is not covered such that the top edges of the side walls are exposed. The open container may be used in a warehouse or the like as a storage solution for easy access, visibility, and handling of stored goods without the need to remove lids or seals. The open container may be, without limitation, a tote, a bin, a bucket, a top-opened box, a crate, a barrel, a cart, or the like.

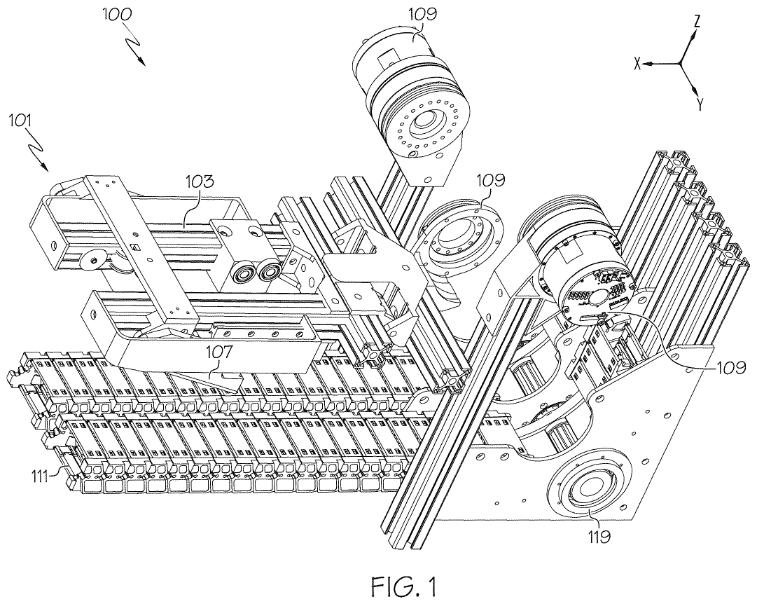

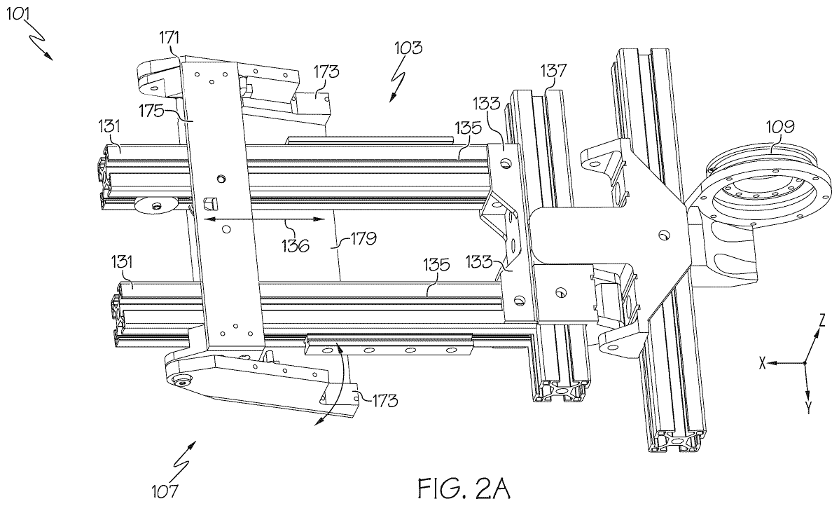

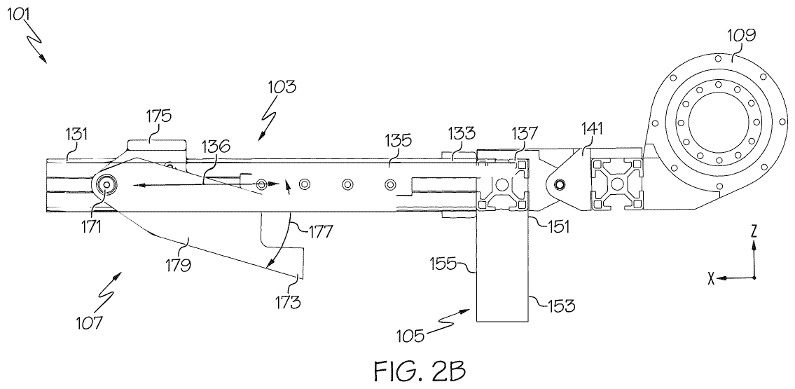

Referring initially to FIGS. 1-2B, an example container gripper assembly 100 for handling open containers, such as totes, is illustrated. A container gripper assembly 100 includes a gripper 101 and a support 111. The gripper 101 includes a base 103, a fixed part 105 vertically coupled to the base 103, and a moving part 107 slidably coupled to the base 103 to move along a longitudinal x-direction 136 of the base 103. The base 103 includes a front end 131 and a back end 133. The fixed part 105 includes a top end 151 and a bottom end 153. The base 103 and the fixed part 105 may be joined at the back end 133 of the base 103 and the top end 151 of the fixed part 105 to form a substantially right angle. The moving part 107 includes a pivot end 171 and a contact end 173. The pivot end 171 may be mechanically coupled to the base 103 through a sliding bar 175 of the moving part 107 to allow the moving part 107 to move along a longitudinal x-direction 136 of the base 103 between the front end 131 and the back end 133.

In some embodiments, as shown in FIGS. 1-2B, the base 103 of the gripper 101 may include one or more bars forming a π shape, with two parallel bars 135 joined at a vertical bar 137 around the back end 133. The two parallel bars 135 may define the longitudinal x-direction 136 of the base 103. It should be appreciated that, in some embodiments, the base 103 may be a plate, one or more bars or tubes forming the π shape, a triangular shape, a rectangular shape, a polygonal shape, or the like, or any shape suitable for the disclosed application herein. The bars, tubes, or the plate may be made of materials of metal (e.g., steel, aluminum, titanium, alloy, etc.), composite, fiber (e.g., carbon fiber), ceramic, polymer (e.g., nylon, polyethylene, polypropylene, polyvinyl chloride (PVC), polyethylene terephthalate (PET), silicone, etc.), or a combination thereof. The base 103 may include one or more track mechanisms along the longitudinal x-direction 136 of the base 103. The moving part 107 may be slidably mounted along the track mechanism on the base 103. For example, as illustrated in FIGS. 1-2B, each parallel bar 135 may include one or more tracks allowing the moving part 107 to move along the longitudinal x-direction 136 of the base 103.

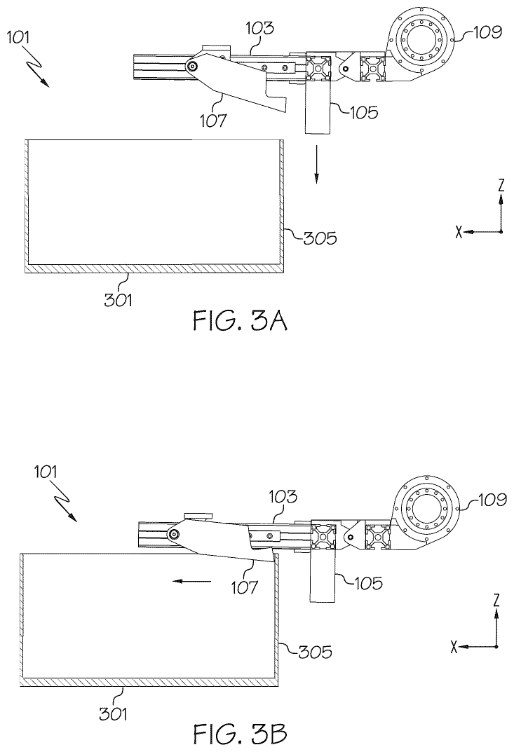

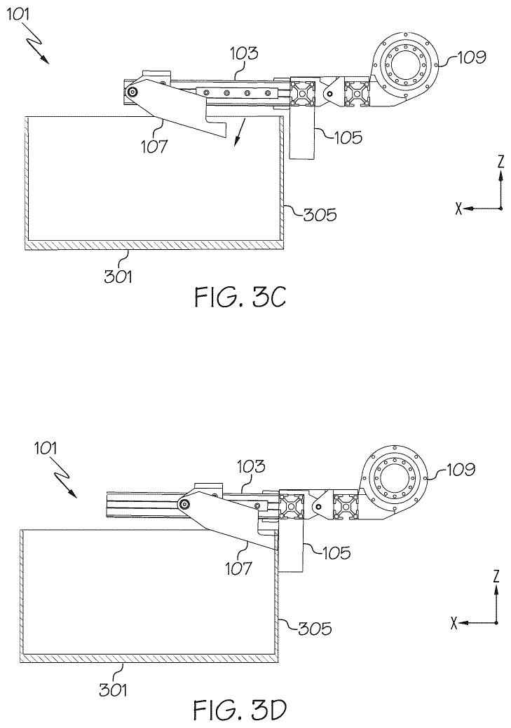

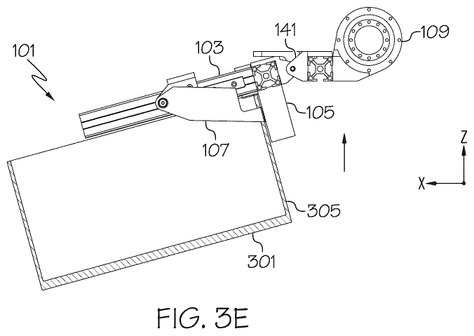

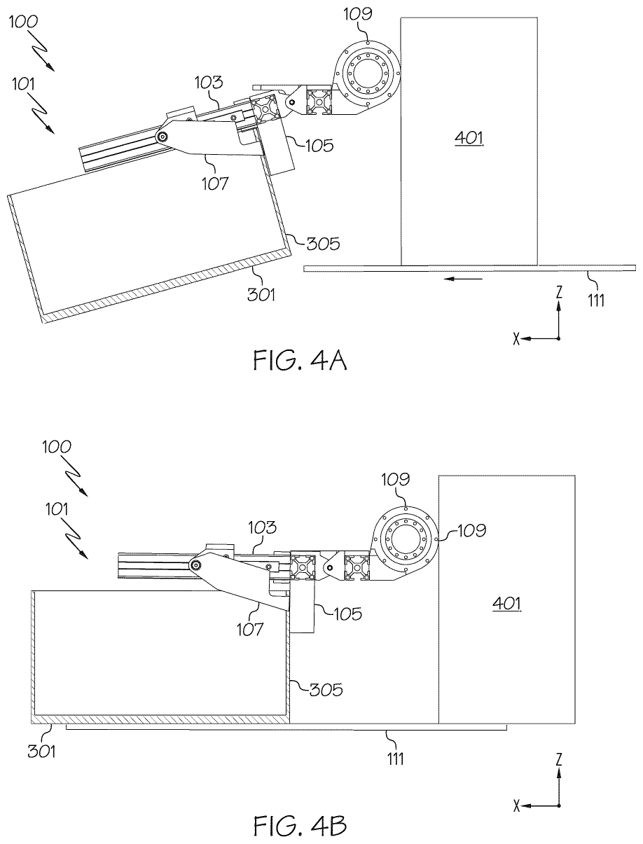

In some embodiments, as illustrated in FIG. 2B, the fixed part 105 may include a bar that joins at the base 103 around the back end 133. For example, as illustrated in FIG. 2B, the fixed part 105 may join the base 103 at the center of a bottom part of the vertical bar 137. It should be appreciated that, in some embodiments, the base 103 may be a plate, one or more bars or tubes forming a π shape, a triangular shape, a rectangular shape, a polygonal shape, or the like, or any shape suitable for the disclosed application herein. The bars, tubes, or the plate may be made of materials of metal (e.g., steel, aluminum, titanium, alloy, etc.), composite, fiber (e.g., carbon fiber), ceramic, polymer (e.g., nylon, polyethylene, polypropylene, polyvinyl chloride (PVC), polyethylene terephthalate (PET), silicone, etc.), or a combination thereof. The fixed part 105 may include a contact surface 155 configured to contact an outer surface of a sidewall 305 of an open container 301 (e.g., in FIGS. 3A-4B). The contact surface 155 of the fixed part 105 may be a flat surface or a contoured surface. The contact surface 155 may include soft, compliant materials, such as, without limitation, rubber, silicone, thermoplastic elastomers, and the like, to enhance the contact or friction force applied to the open container 301.

In some embodiments, as illustrated in FIGS. 1-2B, the moving part 107 may include a sliding bar 175 across a width direction of the base 103. The sliding bar 175 may be slidably coupled to the base 103 through one or more tracks. The moving part 107 may further include a rotation member 179. The rotation member 179 may include, without limitation, a beam component, a rod component, a bar component, one or more pins or joints, or a combination thereof. The beam may be a U-beam, a T-beam, a L-beam, or the like. The rotation member 179 may have the pivot end 171 and the contact end 173. The rotation part 179 may further include a hinged finger structure at the contact end 173 configured to engage an inner surface of the sidewall 305 of the open container 301 (as illustrated in FIGS. 3A-4B). The pivot end 171 may be pivotally coupled to the two ends of the sliding bar 175 such that the rotation part 179 can rotate between an engagement position and a recessed position along pivot end 171. The contact end 173 may space away from the base 103 in the engagement position and move toward contact with a lower surface of the base 103 in the recessed position. It should be appreciated that, in some embodiments, the rotation part 179, instead of coupled to the sliding bar 175, may be directly coupled to the base 103 through a pivot mechanism at the pivot end 171. The pivot end 171 may be further slidably coupled to the base 103, allowing the moving part 107 to move along the longitudinal x-direction 136 of the base 103.

In operation, the gripper 101 may be arranged with the moving part 107 facing downward with the open container 301 lower than the gripper 101 along the z-axis. The contact end 173 may be configured to space away from the base 103 under gravity while the pivot end 171 remains in the same position. The contact end 173 may move toward the lower surface of the base 103 due to physical interaction with the open container 301 that overcomes the gravity (e.g., in FIG. 3B). The moving part 107 may be configured to rotate between an engagement position (i.e., the furthest position for the contact end 173 spacing away from the base 103) and a recessed position (i.e., the closest position for the contact end 173 moving toward the base 103) with a rotation angle 177. In some embodiments, the rotation angle 177 may be 1°, 5°, 10°, 15°, 20°, 25°, 30°, 35°, 40°, 45°, 50°, 60°, 70°, 80°, 90°, or any angle between 0° and 90°.

In some embodiments, the gripper 101 may further include a spring mechanism between the base 103 and the moving part 107 or between the sliding bar 175 and the rotation part 179. The spring mechanism may be, without limitation, a compression spring, an extension spring, a conical spring, a torsion spring, or any type of spring suitable for the application described herein. The spring may be made of, without limitation, metals (e.g., ferrous alloys, non-ferrous alloys), plastics, fibers, and any suitable material suitable for the application described herein. The spring mechanism may be configured to bias the moving part 107 to space away from the base 103. In such a scenario, the contact end 173 may move toward the lower surface of the base 103 due to physical interaction with the open container 301 that overcomes the gravity and/or the elastic force of the spring mechanism.

In some embodiments, the gripper 101 may include one or more sensors. The one or more sensors may be a mechanism switch. The sensors may be operable to monitor a position of the moving part 107. For example, the one or more sensors may be used to detect whether the gripper 101, such as the moving part 107, makes physical contact with the open container 301. The one or more sensors may be used to determine whether the contact end 173 is in the engagement position or in the recessed position. The one or more sensors may be used to detect whether the contact end 173 is engaged with the sidewall 305 of the open container 301 against the contact surface 155 of the fixed part 105 at an inner side of the right angle.

As illustrated in FIGS. 1-2B, the container gripper assembly 100 may further include a motor 109 operable to drive the moving part 107 along the longitudinal x-direction 136. The motor 109 may be mechanically coupled to the moving part 107 through a rack and pinion mechanism, a lead screw and nut mechanism, a timing belt, a chain and sprocket mechanism, and any suitable mechanisms and devices that transfer the motion of the motor 109 to the moving part 107. The motor 109 may be a direct current (DC) motor, an alternating current (AC) motor, a stepper motor, a servo motor, a gear motor, a torque motor, or any motors suitable for the application described herein. The motor 109 may be operable to secure the moving part 107 against the fixed part 105 when the sidewall 305 of the open container 301 is clipped between the moving part 107 and the fixed part 105. The container gripper assembly 100 may further include a passive pivot 141 around the joint of the base 103 and the fixed part 105. The gripper 101 may rotate around the passive pivot 141. For example, as illustrated in FIG. 3E, the gripper 101 may rotate to align itself with the open container 301 when the open container 301 is lifted or tilted. The passing pivotal allows for the gripper 101 to be flexible, and to pick up different types of containers.

In embodiments, the gripper 101 may be mechanically coupled to other components and devices of the container gripper assembly 100 through rotation mechanisms. For example, as illustrated in FIGS. 1-2B, the gripper 101 may connect to the motor 109 through a T-shape mechanism, and the T-shape mechanism may be coupled to a lower part of the container gripper assembly 100 through two horizontal bars or tubes. The lower part of the container gripper assembly 100 may include the support 111. The support 111 may be operable to slide under the open container 301 to support the open container 301 from below. In some embodiments, as illustrated in FIG. 1, the support 111 may include a unidirectional bending chain. The unidirectional bending chain includes a plurality of interlocking links, where each link supports the next in one direction but restricts movement in the opposite direction. Accordingly, the unidirectional bending chain can bend only upward but cannot bend downward. When extended horizontally, the unidirectional bending chain can may act like a rigid beam, supporting the open container 301 or other load. The upward-bending characteristic of the unidirectional bending chain ensures that the chain holds firm when weight is applied from above. Further, the unidirectional bending chain may be retracted through a rolling mechanism 119 (as in FIG. 1) or a similar system to vertically store the unidirectional bending chain, taking up minimal planar space. The rolling mechanism 119 may include a spool or drum that allows the unidirectional bending chain to coil up or fold as it is pulled into the vertical storage position. The extension or retraction of the unidirectional bending chain may be motorized or manually driven.

Referring to FIGS. 3A-3E, an example gripper 101 lifting or tilting an open container 301 is depicted. The non-limiting process of lifting or tilting the open container 301 may include a vertical approaching step (e.g., in FIG. 3A), a horizontal approaching step (e.g., in FIGS. 3B and 3C), a clipping step (e.g., in FIG. 3D), and a lifting/tilting step (e.g., FIG. 3E). It should be appreciated that, in some embodiments, the process of lifting or tilting may include some or none of the steps above, and the steps may not be carried in the sequences described in FIGS. 3A-3E. The gripper 101 in the FIGS. 3A-3E may be included in the container gripper assembly 100 in fulfilling the container handling. It should be appreciated that, in some embodiments, the gripper 101 may not be included in the container gripper assembly 100 but be included in another system, such as a robot system, in fulfilling the lifting and tilting process, or other handling processes, such as, without limitation, pushing, pulling, or rotating the open container 301.

As illustrated in FIG. 3A, the gripper 101 may be placed above the open container 301 in a position where the moving part 107 faces the open container 301 below, and the fixed part 105 outside an area defined by the open container 301 below. Particularly, at least partial moving part 107 may overlap a top edge of one of the sidewalls 305 of the open container 301. During this step, the contact end 173 (as in FIGS. 1-2B) may space away from the base 103 in the engagement position. The gripper 101 may then move towards the open container 301. In some embodiments, the container gripper assembly 100 may use a sensor to determine the position of the gripper 101, particularly the position of the moving part 107, to adjust the position of the gripper 101 for engagement. In some embodiments, a user may operate a moving vehicle or robot in controlling the position of the gripper for engagement. As illustrated in FIG. 3B, as the gripper 101 moves toward the open container 301, a lower surface of the moving part 107 may engage with the top edge of the sidewall 305, which pushes the contact end 173 (as in FIGS. 1-2B) toward the base 103 until the moving part 107 rotates into the recessed position. A sensor, such as a mechanical switch, may detect the moving part 107 entering into the recessed position.

As illustrated in FIG. 3C, once the moving part 107 is pushed by the sidewall 305 into the recessed position, the gripper 101 may be horizontally moved toward the open container 301 until the contact surface 155 (as in FIG. 2B) of the fixed part 105 engages with the outer surface of the sidewall 305. The moving part 107, due to disengaging from the top edge of the sidewall 305, may rotate downward to space away from the base 103 and accordingly be released into the engagement position. As illustrated in FIG. 3D, the motor 109 may drive the moving part 107 to move toward the back end 133 (as in FIGS. 2A-2B) of the base 103 and/or the fixed part 105 until the contact end 173 of the moving part 107 engages with the inner surface of the sidewall 305. As such, the contact end 173 and the contact surface 155 of the fixed part 105 may clip the sidewall 305 of the open container 301. The motor 109 may apply power to allow the contact end 173 to apply sufficient force against the sidewall 305 to the contact surface 155 of the fixed part 105 for further handlings, such as titling and/or lifting. As illustrated in FIG. 3E, once the sidewall 305 is secured by the moving part 107 and the fixed part 105, the gripper 101 may raise to tilt or lift the open container 301, e.g., one side of the open container 301. The gripper 101 may rotate according to the passive pivot 141 to align itself with the open container 301 when the open container 301 is lifted or tilted.

Referring to FIGS. 4A and 4B, an example container gripper assembly 100 sliding the support 111 underneath the tilted or lifted open container 301 in the process of handling the open container 301 is depicted. After the gripper 101 tilts or lifts the open container 301 with a side of the open container, the container gripper assembly 100 may insert and slide the support 111 under the open container 301. The container gripper assembly 100 may include the gripper 101 and the motor 109 coupled to a support operation mechanism 401 with the support 111 that can slidably move under the support operation mechanism 401. The support operation mechanism 401 may be a robot, a robot arm, a forklift, or any systems and apparatuses suitable to operate the support 111 and the gripper 101 as described herein. Once the support 111 slides from the outside of the open container 301 to under the open container 301 sufficiently far to create a stable support of the open container 301, e.g., a contact area of more than 50%, 60%, 70%, 80%, 90%, 99%, or any value between 50% and 100% of a bottom of the open container 301, as illustrated in FIG. 4B, the gripper 101 may release the open container 301 to have the support 111 support the open container 301 for further handling, such as, without limitation, moving, lifting, and throwing the open container 301.

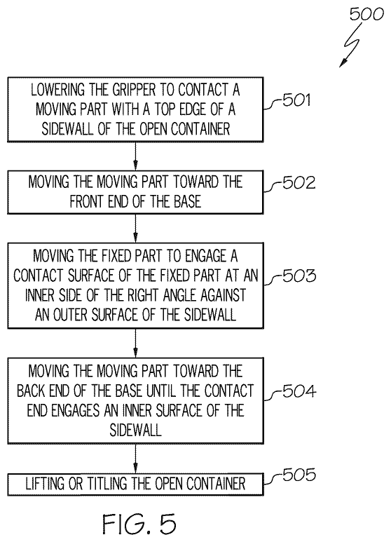

FIG. 5 illustrates a flow diagram of an illustrative method 500 of handling the open container 301 using the open-container gripper assembly 100. At block 501, the method 500 includes lowering the gripper 101 (as in FIGS. 1-2B) to contact a moving part 107 (as in FIGS. 1-2B) with a top edge of a sidewall 305 (as in FIGS. 3A-4B) of the open container (as in FIGS. 3A-4B). The gripper includes a base 103 (as in FIGS. 2A-2B), a fixed part (as in FIGS. 2A-2B), and the moving part 107. The base includes a front end 131 and a back end 133 (as in FIGS. 2A-2B). The fixed part 105 (as in FIGS. 2A-2B) includes a top end 151 (as in FIGS. 2A-2B) and a bottom end 153 (as in FIGS. 2A-2B). The base 103 and the fixed part 105 are joined at the back end 133 of the base 103 and the top end 151 of the fixed part 105 to form a substantially right angle. The moving part 107 includes a pivot end 171 and a contact end 173. The pivot end 171 is mechanically coupled to the base 103 configured to move the moving part 107 along a longitudinal x-direction 136 of the base 103.

At block 502, the method 500 includes moving the moving part 107 toward the front end 131 of the base 103. At block 503, the method 500 includes moving the gripper 101 to engage a contact surface 155 (as in FIG. 2B) of the fixed part 105 at an inner side of the right angle against an outer surface of the sidewall 305. At block 504, the method 500 includes moving the moving part 107 toward the back end 133 of the base 103 until the contact end 173 engages an inner surface of the sidewall 305. At block 505, the method 500 includes lifting or titling the open container.

In some embodiments, the moving part 107 of the gripper 101 may further include a pivot mechanism at the pivot end 171 configured to rotate the moving part 107. The lowering the gripper 101 to contact the moving part 107 with the top edge of the sidewall 305 of the method 500 may further include lowering the gripper 101 until the contact end 173 moves toward to contact a lower surface of the base 103.

In some embodiments, the moving the moving part 107 toward the front end 131 of the base 103 of the method 500 may further include moving the moving part 107 toward the front end 131 of the base 103 until the contact end 173 is spaced away from the base 103 under gravity. The gripper 101 may further include a spring mechanism between the base 103 and the moving part 107. The spring mechanism may bias the moving part 107 to space away from the base 103.

In some embodiments, the base 103 may further include a track mechanism along the longitudinal x-direction 136 of the base 103. The moving part 107 may be slidably mounted along the track mechanism on the base 103. The contact surface 155 of the fixed part 105 may be a flat surface or a contoured surface.

In some embodiments, the container gripper assembly 100 may further include a motor 109 (as in FIGS. 1-2B) operable to drive the moving part 107 toward or away from the fixed part 105. The container gripper assembly 100 may further include one or more sensors operable to monitor a position of the moving part 107. The container gripper assembly 100 may further include a support 111 (as in FIGS. 1 and 4A-4B). The lifting or titling the open container 301 of the method 500 may further include sliding the support 111 under the open container 301 to support the open container 301. The support 111 may include a unidirectional bending chain (e.g., as illustrated in FIG. 1).

It is also noted that recitations herein of “at least one” component, element, etc., should not be used to create an inference that the alternative use of the articles “a” or “an” should be limited to a single component, element, etc.

It is noted that it is in no way intended that any method set forth herein be construed as requiring that its steps be performed in a specific order, nor that with any apparatus specific orientations be required. It is also noted that it will be apparent to those skilled in the art that various modifications and variations can be made to the embodiments described herein without departing from the scope of the claimed subject matter.

It is noted that recitations herein of a component of the present disclosure being “configured,” “operable,” or “programmed” in a particular way, to embody a particular property, or to function in a particular manner, are structural recitations, as opposed to recitations of intended use. More specifically, the references herein to the manner in which a component is “configured,” “operable,” or “programmed” denotes an existing physical condition of the component and, as such, is to be taken as a definite recitation of the structural characteristics of the component.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

What is claimed is:

1. A container gripper assembly for handling an open container, the container gripper assembly comprising a gripper, the gripper comprising:
a base comprising a front end and a back end;
a fixed part comprising a top end and a bottom end, the base and the fixed part joined at the back end of the base and the top end of the fixed part to form a substantially right angle; and
a moving part comprising a pivot end and a contact end, the pivot end mechanically coupled to the base and configured to move the moving part along a longitudinal direction of the base such that the contact end is configured to engage a sidewall of the open container against a contact surface of the fixed part at an inner side of the right angle.

2. The container gripper assembly of claim 1, wherein the moving part comprises a pivot mechanism at the pivot end, the moving part operable to rotate between an engagement position and a recessed position along the pivot mechanism, wherein the contact end is spaced away from the base in the engagement position, and moves toward to contact a lower surface of the base in the recessed position.

3. The container gripper assembly of claim 2, wherein the contact end is configured to space away from the base under gravity and moves toward the lower surface of the base due to physical interaction with the open container that overcomes the gravity.

4. The container gripper assembly of claim 2, wherein the gripper further comprises a spring mechanism between the base and the moving part, the spring mechanism configured to bias the moving part to space away from the base.

5. The container gripper assembly of claim 1, wherein the base further comprises a track mechanism along the longitudinal direction of the base, the moving part is slidably mounted along the track mechanism on the base.

6. The container gripper assembly of claim 1, wherein the contact surface of the fixed part is a flat surface or a contoured surface.

7. The container gripper assembly of claim 1, wherein the container gripper assembly further comprises a motor operable to drive the moving part toward or away from the fixed part.

8. The container gripper assembly of claim 1, wherein the container gripper assembly further comprises a sensor operable to monitor a position of the moving part.

9. The container gripper assembly of claim 1, wherein the container gripper assembly further comprises a support operably sliding under the open container to support the open container.

10. The container gripper assembly of claim 9, wherein the support comprises a unidirectional bending chain.

11. A method for handling an open container using a container gripper assembly comprising a gripper, the method comprising:
lowering the gripper to contact a moving part with a top edge of a sidewall of the open container, wherein the gripper comprises:
a base comprising a front end and a back end;
a fixed part comprising a top end and a bottom end, the base and the fixed part joined at the back end of the base and the top end of the fixed part to form a substantially right angle; and
the moving part comprising a pivot end and a contact end, the pivot end mechanically coupled to the base and configured to move the moving part along a longitudinal direction of the base;
moving the moving part toward the front end of the base;
moving the gripper to engage a contact surface of the fixed part at an inner side of the right angle against an outer surface of the sidewall;
moving the moving part toward the back end of the base until the contact end engages an inner surface of the sidewall; and
lifting or titling the open container.

12. The method of claim 11, the moving part of the gripper further comprising a pivot mechanism at the pivot end configured to rotate the moving part, the lowering the gripper to contact the moving part further comprises lowering the gripper until the contact end moves toward to contact a lower surface of the base.

13. The method of claim 12, wherein the moving the moving part toward the front end of the base further comprises moving the moving part toward the front end of the base until the contact end is spaced away from the base under gravity.

14. The method of claim 13, the gripper further comprises a spring mechanism between the base and the moving part, wherein the spring mechanism biases the moving part to space away from the base.

15. The method of claim 11, wherein the base further comprises a track mechanism along the longitudinal direction of the base, the moving part is slidably mounted along the track mechanism on the base.

16. The method of claim 11, wherein the contact surface of the fixed part is a flat surface or a contoured surface.

17. The method of claim 11, wherein the container gripper assembly further comprises a motor operable to drive the moving part toward or away from the fixed part.

18. The method of claim 11, wherein the container gripper assembly further comprises a sensor operable to monitor a position of the moving part.

19. The method of claim 11, the container gripper assembly further comprising a support, the lifting or titling the open container further comprises sliding the support under the open container to support the open container.

20. The method of claim 19, wherein the support comprises a unidirectional bending chain.
